(19) United States
(12) Patent Application Publication
(10) Pub. No.: US 2007/0291165 A1
(43) Pub. Date: Dec. 20, 2007

(54) Hands-free portable digital video camera device

(76) Inventor: Ming-Yan Wang, Hsin-Chuang City (TW)

Correspondence Address: HERSHKOVITZ & ASSOCIATES, 2845 DUKE STREET, ALEXANDRIA, VA, 22314, US

(21) Appl. No.: 11/455,744

(22) Filed: Jun. 20, 2006

(51) Int. Cl. H04N 5/225

(52) U.S. Cl. 348/372

(57) ABSTRACT

A bands-free portable digital video camera device having an independent digital image capturing device and an independent central processing device wireless connected to the digital image capturing device. The digital image capturing device is used to shoot pictures and then transmit image data of the pictures to the central processing device wireless connected to storage and display. Since the digital video camera is consisted of two independent parts, each part can be made to a small product to directly wear on a user's body to shoot pictures or films. Therefore, the user uses the portable digital video camera device without the user's hand or hands.

### BACKGROUND OF THE INVENTION

1. Field of the Invention

The present invention relates to a portable digital video camera device, and more particularly to a portable digital video camera device having an independent miniature digital image capturing device and an independent central processing device. Therefore, a user directly wears the miniature digital image capturing device and an independent central processing device on his or her body and uses the miniature digital image capturing device without hands.

2. Description of Related Art

In general, a portable digital video camera device is formed to a portable product so the user can use it to capture a picture. Since the related technology of he digital video product is developed quickly, the digital video camera device is not only used to capture pictures but also used to record audio signals to make a film. However, even although the present digital video camera device is small enough, the user still has to use it by hand or hands.

Therefore, if the portable digital video camera device is applied to other specific uses, such as a long-term shooting work or a secret shooting work, the user would not like to move widely. However, the use of the general digital video camera is hard to achieve this goal.

Therefore, the present invention provides a portable digital video camera device having an independent image capturing device and an independent central processing device. The user can wear the image capturing device and not use it by the user's hand or hands.

### SUMMARY OF THE INVENTION

The main objective of the present invention is to provide a portable digital video camera device having an independent and miniature digital image capturing device and an independent central processing device. A user carries the miniature digital image capturing device on his or her body to shoot pictures or films without hands.

A hands-free portable digital video camera device having an independent digital image capturing device and an independent central processing device wireless connected to the digital image capturing device. The portable digital image capturing device is used to shoot pictures and then transmit image data of the pictures to the central processing device wireless connected to storage and display. Since the digital video camera is consisted of two independent parts, each part can be made to a small product to directly wear on a user's body to shoot pictures or films. Therefore, the user uses the digital video camera device without the user's hand or hands.

Other objectives, advantages and novel features of the invention will become more apparent from the following detailed description when taken in conjunction with the accompanying drawings.

### BRIEF DESCRIPTION OF THE DRAWINGS

FIG. 1 is schematic diagram shown a miniature digital image capturing device and a central processing device directly worn on a user's body when the digital video camera device is working;

FIG. 2 is a block diagram of the miniature digital image capturing device in accordance with the present invention; and

FIG. 3 is a block diagram of a central processing device in accordance with the present invention.

### DETAILED DESCRIPTION OF THE PREFERRED EMBODIMENT

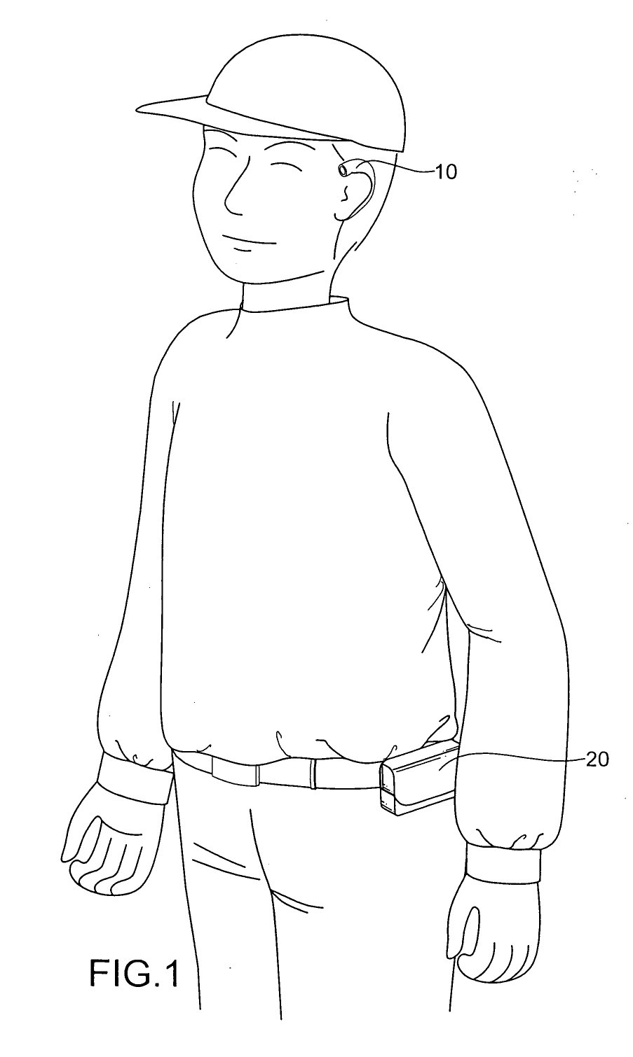

With reference to FIG. 1, a hands-free portable digital video camera device in accordance with the present invention has an independent miniature digital image capturing device (10) and an independent central processing device (20). The miniature independent digital image capturing device (10) is wireless connected to the independent central processing device (20). Since the independent digital image capturing device (10) is small, the user can wear it on his or her body to shoot pictures or films.

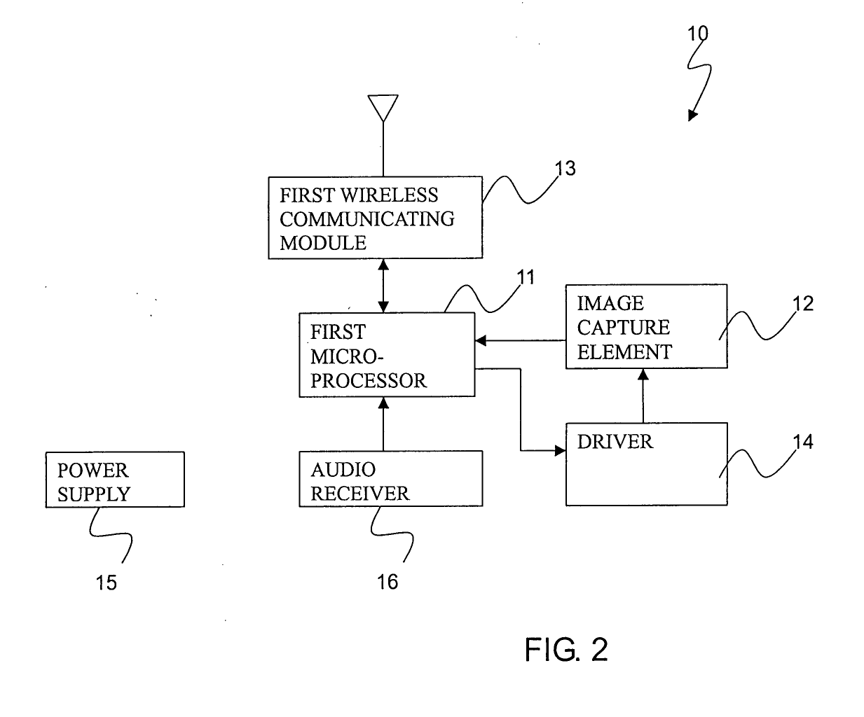

With further reference to FIG. 2, the miniature independent digital image capturing device (10) has a first microprocessor (11), an image capture element (12), a first wireless communicating module (13), a driver (14), a audio receiver (16), and a power supply (15).

An output of image capture element (12) is electronically connected to an input of the first microprocessor (11) and is used to capture the picture or films and then outputs image data of the pictures or films to the first microprocessor (11). An output of the first microprocessor (11) is connected to the image capture element (12) through the driver (14). The image capture element (12) can be a CCD or CMOS module.

The audio receiver (16) is connected to the first microprocessor (11) and used to receive the audio signals and output the audio signals to the first microprocessor (11).

The first wireless communicating module (13) is connected to the first microprocessor (11) to wireless transmit the image data and audio signals to the central processing device (20). The first wireless communicating module (13) is a blue tooth module or RF transmitter and receiver.

The power supply (15) is used to provide power source to the above electronic devices.

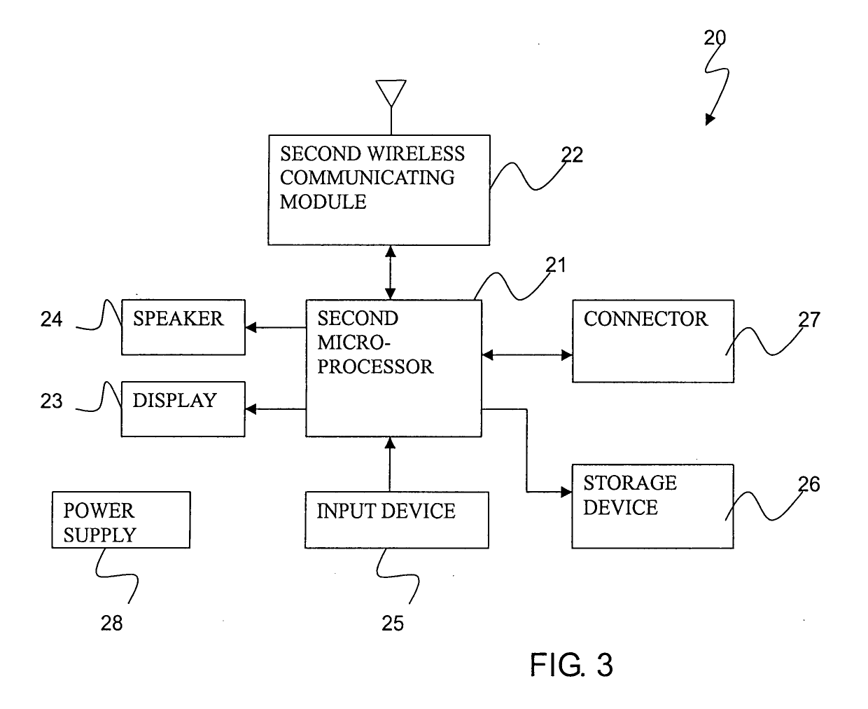

With further reference to FIG. 3, the central processing device has a second microprocessor (21), a second wireless communicating module (22), a storage device (26), an input device (25), a display (23), a speaker (24), a connector (27) and a power supply (28).

The second wireless communicating module (22) is electronically connected to the second microprocessor (21) to establish a wireless connection with the first wireless communicating module (13). Therefore, the second microprocessor (21) receives the image data and audio signals from the image capturing device (10). The second wireless communicating module (22) is a blue tooth module or RF transmitter and receiver.

The storage device (26), the input device (25), the display (23), the speaker (24) and the connector (27) are electronically connected to the second microprocessor (21). The storage device (26) is used to store the image data or audio signals from the digital image capturing device unit (10). The storage device (26) can be a memory, a hard disk or a memory card, disk etc. The input device (25) can be a touch panel or a keyboard to select a specific function of the second microprocessor (21). The connector (27) can be a USB, or 1394 etc. and used to connected to an external electronic device.

The power supply (28) is used to provide the power source to the electronic devices of the central processing unit (20).

With reference to FIGS. 2 and 3, when the image capture element (12) starts to capture the pictures and the audio receiver (16) starts to receive the audio signals, the first microprocessor (11) will receive the image data of the pictures and the audio signals from the image capture element. The first microprocessor (11) processes the image data and audio signals and then outputs to the first wireless communicating module (11). The first wireless communicating module (13) modulates the image data and the audio signals to meet with a specific wireless communicate protocol and then transmits them to the central processing device (20).

The central processing device (20) receives the modulated image data and the audio signals from the digital image capturing device (10) through the second wireless communicating module (22). The second wireless communicating module (22) demodulates the modulated image data and the audio signals and then outputs to the second microprocessor (21). The second microprocessor (21) controls the display (23) and speaker (24) to display and play the image data and the audio signals. Meanwhile, the image data and audio signals are stored in the storage device (26). Therefore, the independent digital image capturing device (10) and the independent central processing device (20) wireless connected to the digital image capturing device (10) has functions of an integrated digital video camera. Furthermore, since the portable digital video camera device has two independent parts, each part can be made to a small product. The user can easily wear them on the user's body to shoot the pictures or films without his or her hand or hands. With reference to FIG. 1, the digital image capturing device (10) is worn on the user's ear. Besides, the digital image capturing device (10) is able to put on the user's shoulder or the like. Further, the central processing device (20)also provides a re-transmitting function. That is, the connector (27) of the central processing device (20) is connected to the external electronic device, such as a personal computer, notebook computer, PDA, mobile phone etc., to transmit the image data and the audio signals stored in the storage device (26) to the external electronic device. If the electronic device has a display unit, the central processing device executes the re-transmitting function to control the display unit of the electronic device to display the image data stored in the storage device.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A hands-free portable digital video camera device, comprising:
an independent miniature digital image capturing device having
a first microprocessor having an operation and transformation capability;
a image capture element electronically connected to the first microprocessor and used to capture image and then output image data to the first microprocessor;
an audio receiver electronically connected to the first microprocessor and used to receive the audio signals and output the audio signals to the first microprocessor;
a first wireless communicating module is electronically connected to the first microprocessor to wireless transmit the image data and the audio signals; and
a power supply providing power source to the first microprocessor, the image capture element, the first wireless communicating module, the audio receiver; and
an independent central processing device wireless connected to the digital image capturing device and having
a second microprocessor having an operation and transformation capability;
a second wireless communicating module electronically connected to the second microprocessor and wireless connected to the first wireless communicating module to establish a wireless connection between the first and second wireless communicating modules, wherein the second wireless communicating module receives the image data and audio signals from the first wireless communicating module and outputs the image data and audio signals to the second microprocessor;
a storage device electronically connected to the second microprocessor to store the image data and the audio signals;
a display electronically connected to the second microprocessor to display the image data;
a speaker electronically connected to the second microprocessor to play the audio signals;
an input device electronically connected to the second microprocessor; and
a power supply providing power source to the second microprocessor, the second wireless communicating module, the storage device, and the display.

2. The hands-free portable digital video camera device as claimed in claim 1, wherein the independent miniature digital image capturing device further comprises a driver electronically connected between the first microprocessor and the image capture element, wherein the first microprocessor controls the image capture element's operation through the driver.

3. The hands-free portable digital video camera device as claimed in claim 1, wherein the image capture element is a CCD or a COMS module.

4. The hands-free portable digital video camera device as claimed in claim 1, wherein either the first wireless communicating module or the second wireless communicating module is a blue tooth module or a RF transmitter and receiver.

5. The hands-free portable digital video camera device as claimed in claim 1, wherein the independent central processing device further comprises a connector electronically connected to the second microprocessor.

6. The hands-free portable digital video camera device as claimed in claim 5, wherein the connector is a USB connector.

7. The hands-free portable digital video camera device as claimed in claim 5, wherein the storage device is a hard disk.

8. The hands-free portable digital video camera device as claimed in claim 5, wherein the storage device is a memory.

9. The hands-free portable digital video camera device as claimed in claim 5, wherein the storage device is a memory card.

10. The hands-free portable digital video camera device as claimed in claim 5, wherein the storage device is a disk.
